(19) United States
(12) Patent Application Publication
(10) Pub. No.: US 2005/0128740 A1
(43) Pub. Date: Jun. 16, 2005

(54) Multipurpose led flashlights and components thereof

(76) Inventors: Robert M. Currie, Dollard-Des-Ormeaux (CA); Eliot Sorella, Laval (CA)

Correspondence Address: MEREK, BLACKMON & VOORHEES, LLC, 673 South Washington Street, Alexandria, VA, 22314, US

(21) Appl. No.: 10/933,471

(22) Filed: Sep. 3, 2004

Related U.S. Application Data
(60) Provisional application No. 60/500,257, filed on Sep. 5, 2003.
(60) Provisional application No. 60/499,351, filed on Sep. 3, 2003.
(60) Provisional application No. 60/499,350, filed on Sep. 3, 2003.

(51) Int. Cl. F21L 4/04

(52) U.S. Cl. 362/200

(57) ABSTRACT

A combination lamp, flashlight and battery housing for use with LED lighting. The lamp incorporates a recharging base for use with removable flashlights. Another flashlight embodiment includes light transmissive case for producing 360° light. The battery housing includes positive and negative terminals at each end.

### CLAIM FOR PRIORITY

Applicants hereby claim priority from U.S. Provisional Patent Application Ser. No. 60/500,257 filed Sep. 5, 2003 and U.S. Provisional Patent Application Ser. No. 60/499,351 filed Sep. 3, 2003 and U.S. Provisional Patent Application Ser. No. 60/499,350 filed Sep. 3, 2003. All three Provisional Patent Applications are incorporated herein by reference.

### FIELD OF THE INVENTION

The invention relates to lighting appliances and more particularly to flashlights and components thereof including battery packs and LED lighting elements.

### BACKGROUND OF THE INVENTION

Locating a flashlight within easy reach is important in the dark and it also helps to have a flashlight in a consistant location. Previous examples of rechargeable flashlights were connected to a charger plugged into a wall socket. The problem with the prior flashlights was that it was difficult to find in the dark. Therefore, the placement of a flashlight in the base of a lamp renders the flashlight ready for use and easily accessible. The use of light emitting diodes (LEDs) in flashlights provides several advantages over conventional bulb lights including low energy usage and bright light and long life as compared to conventional incandescent flashlight bulbs. The small size of LEDs allows for configuration alterations of flashlights.

### OBJECTS AND SUMMARY OF THE INVENTION

It is an object of the invention to provide a lamp having a charging base for removable and rechargeable flashlights.

Another object of the invention is to provide flashlights in the form of tubes.

Yet another object of the invention is to provide a recharging base for removable and rechargeable flashlights that turn on automatically when power to the recharging base is interrupted.

Still another object of the invention is to provide a flashlight having a light transmissive case which can emit light in 360°.

Still another object of the invention is to provide a flashlight having a lighted wand extension.

Yet another object of the invention is to provide a flashlight having a light transmissive case and a partial reflector to deflect a portion of emitted light into the case and also provide a beam of light.

Still another object of the invention is to provide a battery housing which includes both positive and negative terminals at each end.

It is a further object of the invention to provide a flashlight which incorporates a battery housing having both positive and negative terminals at each end to provide a light source at each end of the flashlight.

These and other objects of the present invention will be readily apparent upon review of the following detailed description of the invention and the accompanying drawings. These objects of the present invention are not exhaustive and are not to be construed as limiting the scope of the claimed invention.

In summary, the invention involves flashlights useable with a recharging socket in a lamp base to provide removeable flashlights for use during power interruptions or can be used as decorative lighting in combination with an incandescent lamp. The invention also contemplates a flashlight that is convertible to a lantern to provide 360° light using LEDs. The invention further contemplates a battery case for holding a plurality of batteries and providing both positive and negative terminals at each end of the case.

With these and other considerations in mind, as will become apparent hereinafter, the invention includes certain novel features of construction, combination and arrangement of parts and portions as will be set forth in the appended claims, reference being had to the accompanying drawings and detailed description thereof.

### BRIEF DESCRIPTION OF THE DRAWINGS

FIG. 1 is an elevational view of a lamp having four rechargeable flashlights in the base sockets;

FIG. 2 is a top view of the lamp of FIG. 1 with the lampshade removed;

FIG. 3 is a side view of a battery case;

FIG. 4 is an end view of the battery case showing the positive and negative terminals;

FIG. 5 is a side view of a second embodiment of a flashlight construction;

FIG. 6 is a sectional view of flashlight construction of FIG. 5;

FIG. 7 is an enlarged view of the LED base; and,

FIG. 8 is an exploded view of the flashlight of FIG. 5.

FIG. 9 shows a wand for attachment to the flashlight of FIG. 5.

### DETAILED DESCRIPTION OF THE INVENTION

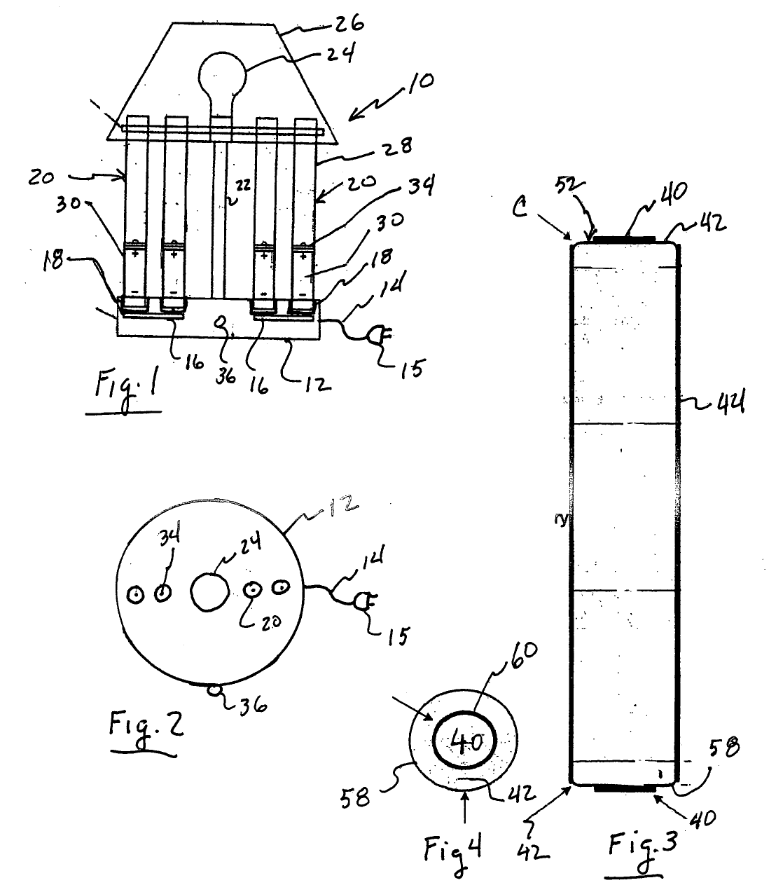

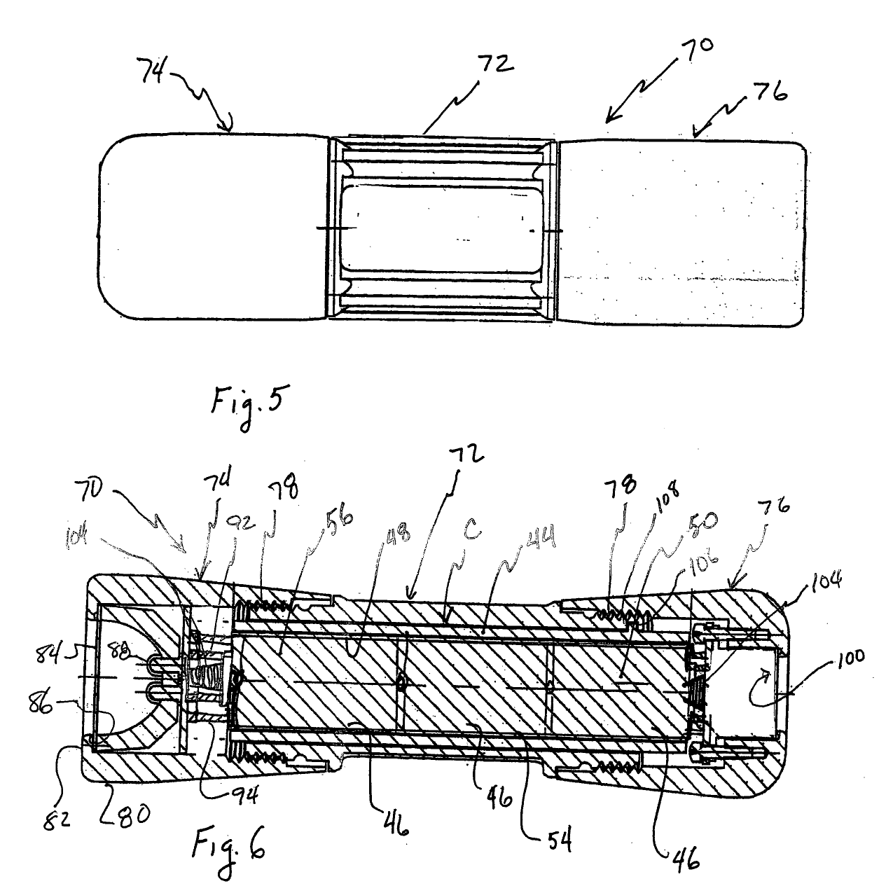

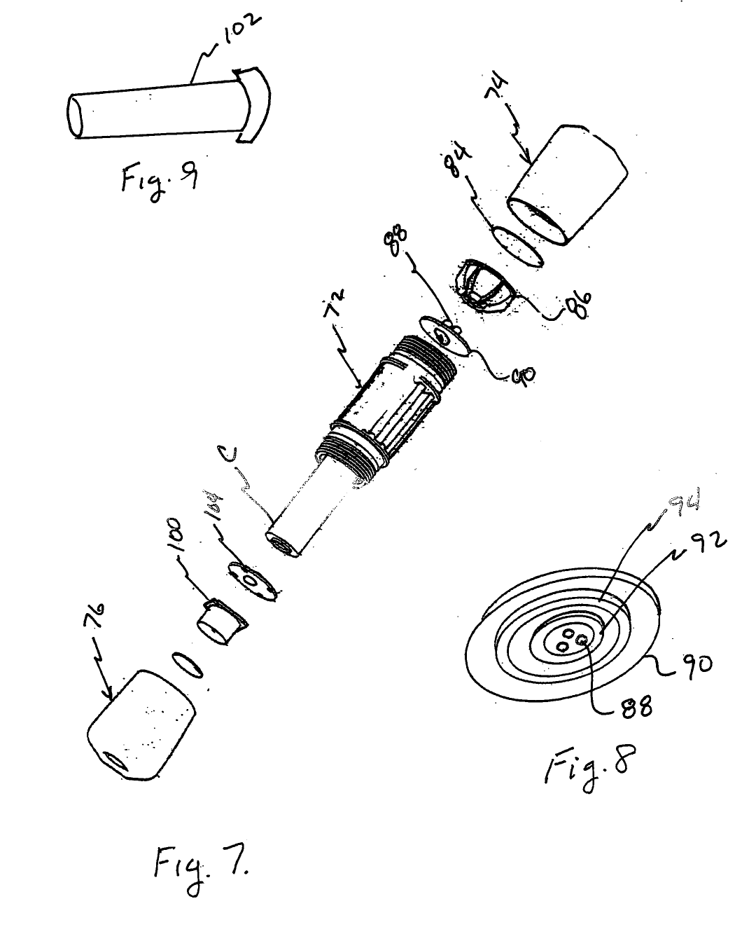

Now with reference to FIGS. 1 and 2, a lamp 10 is shown having a base 12. The base 12 includes a power cord 14 for supplying power from a conventional wall socket throught plug 15 to the lamp 10. The base 12 also includes printed circuit boards 16 electrically connected to the power cord 14. The printed circuit boards 16 include a stepdown transformer circuit to convert household current to a low voltage direct current. Sockets 18 are formed in the base 12 and are electrically connected to the printed circuit boards 16 to form recharging stations for rechargeable flashlights 20. Extending from base 12 is a post 22 for supporting an incandescent light 24 and a lampshade 26. The rechargeable flashlights 20 are preferably formed of tubes 28 of acrylic material which may be transparent or opaque and have a battery 30 at the lower end of each tube 28. A charging circuit of conventional design may be incorporated into the lower end of each tube 28 or a battery case C as described with reference to FIGS. 3 and 4 may be used.

A light emitting diode 34 is positioned above the battery 30 and is connected to the battery so that light may be emitted from the tube 28. The light emitting diodes 34 may be designed to emit white light or colored light. The flashlights 20 are designed to be used separately from the incandescent light 24 but may also be used in combination. A switch 36 is located on the base 12 for turning on and off either the flashlights 20 or the incandescent light 24 and also includes a power interrupt setting to automatically turn on the flashlights 20 when power from the power cord 14 is interrupted.

Now with reference to FIGS. 3, 4 and 6, a battery case C preferably formed of polycarbonate is shown having both positive 40 and negative 42 terminals at each end. This is accomplished by forming a housing 44 for holding a plurality of stacked batteries 46. In the most preferred embodiment the stacked batteries 46 are three C cell batteries each having a voltage of 1.2 volts dc. Stacking three C cell batteries provides a total of 3.6 volts dc. The battery cells 46 are preferably either NiCd or NiMh but throwaway batteries could also be used. A conductor strip 48 connected from the negative terminal of the most rear C cell battery 50 runs along the entire stack 46 and connects to a terminal cap 52. Another conductor strip 54 connected from the positive terminal of the most front C cell battery 56 and runs along the entire stack and connects to terminal cap 58. The terminal caps 52 and 58 will also connect to the polarity of the battery at that particular terminal end, i.e. 50 and 56 respectively. A nonconductive insulating ring 60 isolates the polarity at each of the terminal caps 52 and 58. It should be understood that different batteries having different voltages may be employed depending on the desired application. The preferred embodiment having three C cell batteries is most advantageous for use with light emitting diodes requiring 3.6 volts.

An alternate flashlight 70 is shown in FIGS. 5 through 8 which also utilizes the battery case C of FIGS. 3 and 4. As shown in FIG. 5, the flashlight 70 includes a central housing 72 formed preferably of light transmissive material such as ABS plastic. A pair of removable end portions 74 and 76 preferably constructed of the same light transmissive material are joined to the central housing 72 preferably by screw threads 78 as shown in FIG. 6, but may also be joined by other conventional connectors. End portion 74 includes a lens cap 80 having a lens retaining lip 82 for retaining lens 84 in place. Adjacent lens 84 is a reflector 86 for focusing light emitted from light emitting diodes 88 to create a beam of light. Light emitting diodes 88 are mounted on a substrate 90 having terminal engaging rings 92 and 94 located thereon for engaging the positive and negative terminals of one of the terminal caps 52 or 58 of the battery case C held within the central housing 72. In the flashlight 70 the battery case C has a white or other colored reflective material.

Preferably, lens cap 80 includes a reflective surface at the retaining lip 82 which is beveled or canted to reflect a portion of the forward light beam back into the light transmissive plastic material forming the housing 72 thus illuminating the housing 72 and providing 360° light simultaneously with a beam of light through lens 84.

A conical reflective lens 100 may be stored at end portion 76. When 360° light is desired, the end portion 76 may be attached to replace end portion 74 so that light emitted from the light emitting diodes is reflected back into the housing 72. Reflector 86 and lens 100 combine to direct the majority of the lumens produced by the LEDs back into the light transmissive plastic material resulting in light emanating from the housing 72 in 360°.

Emergency personnel as well as police commonly use conventional flashlights having a colored extension tube when directing traffic at night. Therefore, flashlight 70 may include a wand 102 shown in FIG. 9 attached in place of end portion 76 when end portion 76 has been relocated to replace end portion 74 to provide an illuminated wand 102 and flashlight 70.

End 76 may also contain additional light emitting diodes 104 in electrical contact with the positive and negative terminals of battery case C.

To operate the flashlight 70 ends 74 and 76 are screwed down tight to central housing 72 so that terminal engaging rings 92 and 94 contact the positive and negative terminals of one of the terminal end caps 52 or 58. When ends 74 and 76 are slightly unscrewed, spring 104 pushes the substrate 90 away from battery case C and continuity of the circuit is broken and the light emitting diodes 88 turn off.

Battery case C includes a flange 106 which engages with a receiving slot 108 in the central housing 72 to lock the battery case C in position.

While this invention has been described as having a preferred design, it is understood that it is capable of further modifications, uses and/or adaptations of the invention following in general the principle of the invention and including such departures from the present disclosure as come within the known or customary practice in the art to which the present invention pertains and as maybe applied to the central features hereinbefore set forth, and fall within the scope of the invention and the limits of the appended claims.

1. A lamp assembly, comprising;
a) a base for supporting a light fixture, said base being adapted to supply electricity to said light fixture;
b) said light fixture including a plurality of tubes extending upwardly from said base;
c) each of said tubes being having a light emitting diode incorporated therein.

2. The lamp assembly as set forth in claim 1, wherein:
a) said tubes are formed of opaque material.

3. The lamp assembly as set forth in claim 1, wherein:
a) said tubes are formed of translucent acrylic material.

4. The lamp assembly as set forth in claim 3, wherein:
a) said tubes are formed of acrylic.

5. The lamp assembly as set forth in claim 4, wherein:
a) said acrylic tubes are of different colors.

6. The lamp assembly as set forth in claim 1, wherein:
a) said light emitting diodes emit light of different colors.

7. The lamp assembly as set forth in claim 1, wherein:
a) said light fixture includes an incandescent light bulb operably associated with said base.

8. The lamp assembly as set forth in claim 7, wherein:
a) said incandescent light bulb is operable independently of said light emitting diodes.

9. A lamp having a removable light assembly, comprising;
a) a base for supporting a light fixture and a removable light;
b) said base further including a removable light support socket;
c) said base being adapted for supplying power to said light fixture and said removable light support socket;
d) said removable light having a rechargeable battery therein and said support socket being electrically connected to said power supply and forms a charging base for recharging said rechargeable battery.

10. The lamp assembly as set forth in claim 9, wherein:
a) said light fixture is adapted to support and operate an incandescent light bulb.

11. The lamp assembly as set forth in claim 9, wherein:
a) said removable light having a light emitting diode therein.

12. The lamp assembly as set forth in claim 9, wherein:
a) said removable light being operable as a flashlight after being removed from said base.

13. The lamp assembly as set forth in claim 9, wherein:
a) said removable light being operable as a light while engaged with said base.

14. The lamp assembly as set forth in claim 9, wherein:
a) said removable light includes an acrylic tube.

15. The lamp assembly as set forth in claim 13, wherein:
a) said tube is formed of opaque material.

16. The lamp assembly as set forth in claim 13, wherein:
a) said tube is formed of translucent acrylic material.

17. The lamp assembly as set forth in claim 19, wherein:
a) said base includes a plurality of sockets for simultaneously charging a plurality of removable lights.

18. A battery pack comprising:
a) an elongated tubular housing for retaining a stacked plurality of batteries, said stacked plurality of batteries having a positive terminal at a top end and a negative terminal at a bottom end.
b) said housing having a first terminal cap adjacent the positive terminal of said stacked plurality of batteries and a second terminal cap located adjacent said bottom end;
c) each terminal cap includes a dual polarity contact surface;
d) said housing includes a negative conductor strip extending from said negative terminal and running along said stacked plurality of batteries and connects to said first terminal cap and said housing also includes a positive conductor strip extending from said positive terminal and running along said stacked plurality of batteries and connects to said second terminal cap;
e) each dual polarity contact surface includes a non-conductive divider for separating the positive polarity contact surface from the negative polarity contact surface.

19. The battery pack as set forth in claim 18, wherein:
a) said plurality of stacked batteries includes three C cell batteries stacked end to end.

20. The battery pack as set forth in claim 19, wherein:
a) the battery cells are made of NiCd.

21. The battery pack as set forth in claim 19, wherein:
a) the battery cells are made of NiMh.

22. A flashlight comprising:
a) an elongated hollow tubular flashlight case formed of light transmissive material and sized to retain a battery therein, said case having a first access opening at a first end and a second access opening at the opposite end;
b) said case having a first end cap adjacent to said first access opening and a second end cap adjacent to said second access opening;
c) said first end cap forms a lens cap for retaining a lens and a reflector and a light emitting diode;
d) a light reflective surface is located around and inside of said lens cap and configured to reflect a portion of the light produced by said light emitting diode back into said light transmissive material to produce 360° of light about said flashlight case.

23. A flashlight comprising:
a) an elongated hollow tubular flashlight case formed of light transmissive material and sized to retain a battery therein, said case having a first access opening at a first end and a second access opening at the opposite end;
b) said case having a first end cap adjacent to said first access opening and a second end cap adjacent to said second access opening;
c) said first end cap forms a lens cap for retaining a full reflective lens and a light emitting diode;
d) whereupon in operation all of said light produced by said light emitting diode is reflected back into said light transmissive material to produce 360° of light about said flashlight case.

24. A flashlight comprising:
a) an elongated hollow tubular flashlight case formed of light transmissive material and sized to retain a battery therein, said case having a first access opening at a first end and a second access opening at the opposite end;
b) said case having a first end cap adjacent to said first access opening and a second end cap adjacent to said second access opening;
c) said first end cap forms a lens cap for retaining a lens and a reflector and a light emitting diode;
d) a light reflective surface is located around and inside of said lens cap and configured to reflect a portion of the light produced by said light emitting diode back into said light transmissive material to produce 360° of light about said flashlight case.

25. A flashlight comprising:
a) an elongated hollow tubular flashlight case formed of light transmissive material and sized to retain a battery therein, said case having a first access opening at a first end and a second access opening at the opposite end;
b) said case having a first end cap connected thereto adjacent to said first access opening and a wand formed of light transmissive material connected to said case adjacent to said second access opening;
c) said first end cap forms a lens cap for retaining a full reflective lens and a light emitting diode;
d) whereupon in operation all of said light produced by said light emitting diode is reflected back into said light transmissive material of said case and said wand to produce 360° of light about said flashlight case and said wand.

26. The flashlight as set forth in claim 23 further comprising;
a) a battery housing located within said flashlight case for housing a plurality of batteries;
b) said battery housing having first and second ends and further including a positive and a negative terminal at each of said first and second ends; and
c) a second light producing element is located in said second end cap, said second light producing element being operably connected to said positive and negative terminals at said second end to produce light.
